(19) United States
(12) Patent Application Publication
(10) Pub. No.: US 2015/0153797 A1
(43) Pub. Date: Jun. 4, 2015

(54) POWER SUPPLY SYSTEM

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: XIN WANG, Shenzhen (CN); YUAN-XI CHEN, Shenzhen (CN); YA-JUN PAN, Shenzhen (CN)

(21) Appl. No.: 14/473,217

(22) Filed: Aug. 29, 2014

(30) Foreign Application Priority Data
Nov. 30, 2013 (CN) 201310622877X

(51) Int. Cl. G06F 1/26; G05F 1/625

(52) U.S. Cl. CPC G06F 1/26; G05F 1/625

(57) ABSTRACT

A power supply system includes a power supply unit (PSU) and a motherboard. The PSU includes a control chip. The motherboard includes a voltage regulator, a first resistor, and a second resistor. The voltage regulator includes an input terminal coupled to the PSU to receive a first voltage, and an output terminal outputting a second voltage regulated from the first voltage by the voltage regulator. The output terminal of the voltage regulator is grounded through the first resistor and the second resistor. A node between the first and second resistors functions as a feedback point and is coupled to the control chip. The control chip fine-tunes the first voltage according to a voltage fed back from the feedback point, to make the output terminal of the voltage regulator steadily output the second voltage.

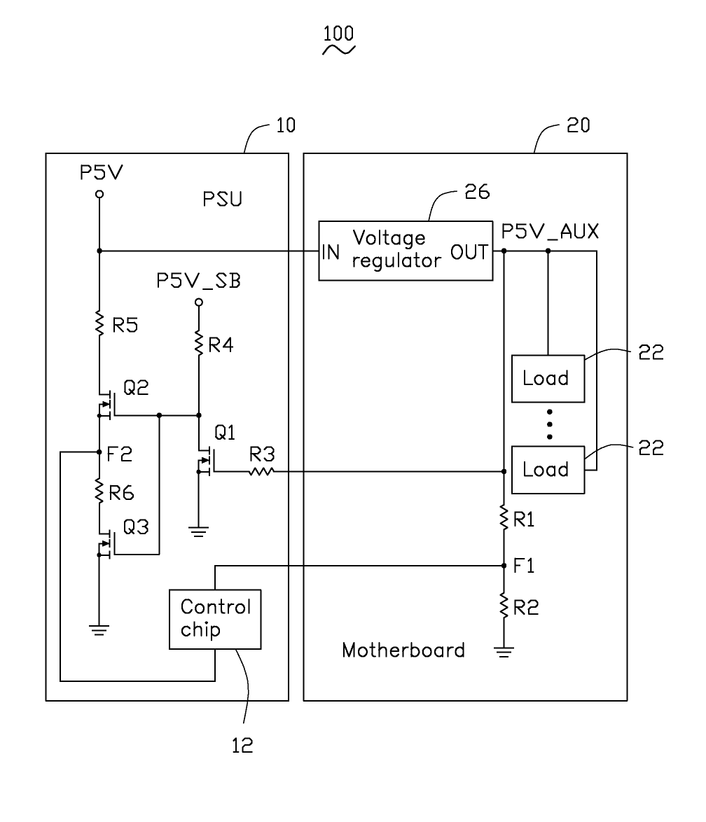

### CROSS-REFERENCE TO RELTATED APPLICATIONS

This application claims priority to Chinese Patent Application No. 201310622877.X filed on Nov. 30, 2013 in the China Intellectual Property Office, the contents of which are incorporated by reference herein.

### FIELD

The subject matter herein generally relates to a power supply system.

### BACKGROUND

In motherboards of servers, a 5 volt (V) auxiliary voltage is regulated from a voltage offered by a power supply unit.

### BRIEF DESCRIPTION OF THE DRAWING

Implementations of the present technology will now be described, by way of example only, with reference to the attached FIGURE, wherein:

The FIGURE is a circuit diagram of an embodiment of an overvoltage protection circuit.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The FIGURE illustrates an embodiment of a power supply system 100. The power supply system 100 can comprise a power supply unit (PSU) 10 and a motherboard 20. The motherboard 20 can comprise a first resistor R1, a second resistor R1, a plurality of loads 22, and a voltage regulator 26. The PSU 10 can comprise a control chip 12, a first electronic switch Q1, a second electronic switch Q2, a third electronic switch Q3, a third resistor R3, a fourth resistor R4, a fifth resistor R5, and a sixth resistor R6. In at least one embodiment, the loads 26 can be a central processing unit, a south bridge, a north bridge, or other electronic elements of the motherboard 20.

The voltage regulator 26 can comprise an input terminal IN electrically coupled to the PSU 10 to receive a first voltage P5V, and an output terminal OUT electrically coupled to the load 22 to output a second voltage P5V_AUX to the load 22. The output terminal OUT of the voltage regulator 26 is further electrically coupled to a ground through the first resistor R1 and the second resistor R2 in that order. A node between the first resistor R1 and the second resistor R2 functions as a first feedback point F1 and is electrically coupled to the control chip 12. The first voltage P5V is regulated to the second voltage P5V_AUX by the voltage regulator 26.

Each of the first electronic switch Q1, the second electronic switch Q2, and the third electronic switch Q3 comprises a first terminal, a second terminal, and a third terminal. The first terminal of the first electronic switch Q1 is electrically coupled to the output terminal OUT of the voltage regulator 26 through the third resistor R3. The second terminal of the first electronic switch Q1 receives a third voltage P5V_SB output from the PSU 10 through the fourth resistor R4. The third terminal of the first electronic switch Q1 is electrically coupled to a ground. The first terminal of the second electronic switch Q2 is electrically coupled to the second terminal of the first electronic switch Q1. The second terminal of the second electronic switch Q2 is electrically coupled to the output terminal OUT of the voltage regulator 26 through the fifth resistor R5. The third terminal of the second electronic switch Q2 functions as a second feedback point F2 and is electrically coupled to the control chip 12. The first terminal of the third electronic switch Q3 is electrically coupled to the second terminal of the first electronic switch Q1. The second terminal of the third electronic switch Q3 is electrically coupled to the third terminal of the second electronic switch Q2 through the sixth resistor. The third terminal of the third electronic switch Q3 is electrically coupled to a ground.

When the motherboard 20 does not boot, the output terminal OUT of the voltage regulator 26 outputs no voltage, the first electronic switch Q1 is turned off, the second electronic switch and the third electronic switch Q3 are turned on. The control chip 12 fine-tunes the first voltage (P5V) according to a voltage fed back from the second feedback point F2.

When the motherboard 20 boots, the output terminal OUT of the voltage regulator 26 outputs the second voltage P5V_AUX to power the loads 22. The first electronic switch Q1 is turned on, and the second electronic switch Q2 and the third electronic switch Q3 are turned off. The control chip 12 fine-tunes the first voltage P5V according to a voltage fed back from the first feedback point F1, to make the output terminal OUT of the voltage regulator 26 output the second voltage P5V_AUX steadily.

In at least one embodiment, the first voltage P5V can be a 5 volt (V) voltage, the second voltage P5V_AUX is a 5V auxiliary voltage, and the third voltage P5V_SB is a 5V standby voltage. A resistance of the first resistor R1 is equal to a resistance of the fifth resistor R5, and a resistance of the second resistor R2 is equal to a resistance of the sixth resistor R6. Each of the first electronic switch Q1, the second electronic switch Q2, and the third electronic switch Q3 can be an n-channel metal-oxide semiconductor field-effect transistor (NMOSFET), and the first terminal, the second terminal, and the third terminal of each of the first electronic switch Q1, the second electronic switch Q2, and the third electronic switch Q3 correspond to a gate, a drain, and a source of the NMOSFET, respectively. In other embodiments, each of the first electronic switch Q1, the second electronic switch Q2, and the third electronic switch Q3 may be an npn-type bipolar junction transistor or other suitable switch having similar functions.

As detailed above, the control chip 12 fine-tunes the first voltage P5V according to the voltage fed back from the first feedback point F1 and the voltage fed back from the second feedback point F2, to make the output terminal OUT of the voltage regulator 26 output the second voltage P5V_AUX steadily to the load 22. Therefore, the load 22 is powered by the second voltage P5V_AUX and can be protected from damage.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including matters of shape, size and arrangement of the parts within the principles of the present disclosure, up to and including the full extent established by the broad general meaning of the terms used in the claims.

What is claimed is:

1. A power supply system comprising:
a power supply unit (PSU) comprising a control chip; and
a motherboard comprising:
a first resistor;
a second resistor;
a plurality of loads; and
a voltage regulator comprising an input terminal electrically coupled to the PSU to receive a first voltage, and an output terminal electrically coupled to the loads to output a second voltage to the loads and electrically coupled to a ground through the first resistor and the second resistor in that order, a node between the first resistor and the second resistor functioning as a first feedback point and electrically coupled to the control chip;
wherein the first voltage is regulated to the second voltage by the voltage regulator, and the control chip fine-tunes the first voltage according to a voltage fed back from the first feedback point, to make the output terminal of the voltage regulator steadily output the second voltage.

2. The power supply system of claim 1, wherein the PSU comprises:
a third resistor;
a fourth resistor;
a fifth resistor;
a sixth resistor;
a first electronic switch comprising a first terminal electrically coupled to the output terminal of the voltage regulator, a second terminal receiving a third voltage output from the PSU through the fourth resistor, and a third terminal electrically coupled to a ground;
a second electronic switch comprising a first terminal electrically coupled to the second terminal of the first electronic switch, a second terminal electrically coupled to the input terminal of the voltage regulator through the fifth resistor, and a third terminal functioning as a second feedback point and electrically coupled to the control chip; and
a third electronic switch comprising a first terminal electrically coupled to the second terminal of the first electronic switch, a second terminal electrically coupled to the third terminal of the second electronic switch through the sixth resistor, and a third terminal electrically coupled to a ground;
wherein in response to the output terminal of the voltage regulator outputting the second voltage, the first electronic switch is turned on, the second electronic switch and the third electronic switch are turned off, and the control chip fine-tunes the first voltage according to the voltage fed back from the first feedback point; and
wherein in response to the output terminal of the voltage regulator outputting no voltage, the first electronic switch is turned off, the second electronic switch and the third electronic switch are turned on, and the control chip fine-tunes the first voltage according to a voltage fed back from the second feedback point.

3. The power supply system of claim 2, wherein each of the first electronic switch, the second electronic switch, and the third electronic switch is an n-channel metal-oxide semiconductor field-effect transistor (NMOSFET), and the first terminal, the second terminal, and the third terminal of each of the first electronic switch, the second electronic switch, and the third electronic switch are respectively corresponding to a gate, a drain, and a source of the NMOSFET.

4. The power supply system of claim 2, wherein a resistance of the first resistor is equal to a resistance of the fifth resistor, and a resistance of the second resistor is equal to a resistance of the sixth resistor.

5. The power supply system of claim 2, wherein the third voltage is a 5 volt (V) standby voltage.

6. The power supply system of claim 1, wherein the first voltage is a 5V voltage and the second voltage is a 5V auxiliary voltage.

7. A power supply system comprising:
a power supply unit (PSU) including a control chip and a motherboard, the motherboard comprising:
a first resistor;
a second resistor;
a plurality of loads; and
a voltage regulator comprising:
an input terminal electrically coupled to the PSU and configured to receive a first voltage;
an output terminal electrically coupled to the loads and a ground through the first resistor and the second resistor, in that order, and configured to output a second voltage to the loads; and
a node electrically coupled to the control chip interposed between the first resistor and the second resistor, the node functioning as a first feedback point,
wherein the first voltage is regulated to the second voltage by the voltage regulator, and the control chip is configured to adjust the first voltage according to a voltage fed back from the first feedback point, thereby enabling the output terminal of the voltage regulator to output the second voltage steadily.

8. The power supply system of claim 7, wherein the PSU comprises:
a third resistor;
a fourth resistor;
a fifth resistor;
a sixth resistor;
a first electronic switch comprising a first terminal electrically coupled to the output terminal of the voltage regulator, a second terminal receiving a third voltage output from the PSU through the fourth resistor, and a third terminal electrically coupled to a ground;
a second electronic switch comprising a first terminal electrically coupled to the second terminal of the first electronic switch, a second terminal electrically coupled to the input terminal of the voltage regulator through the fifth resistor, and a third terminal functioning as a second feedback point and electrically coupled to the control chip; and
a third electronic switch comprising a first terminal electrically coupled to the second terminal of the first electronic switch, a second terminal electrically coupled to the third terminal of the second electronic switch through the sixth resistor, and a third terminal electrically coupled to a ground;
wherein in response to the output terminal of the voltage regulator outputting the second voltage, the first electronic switch is turned on, the second electronic switch and the third electronic switch are turned off, and the control chip fine-tunes the first voltage according to the voltage fed back from the first feedback point; and
wherein in response to the output terminal of the voltage regulator outputting no voltage, the first electronic switch is turned off, the second electronic switch and the third electronic switch are turned on, and the control chip fine-tunes the first voltage according to a voltage fed back from the second feedback point.

9. The power supply system of claim 8, wherein each of the first electronic switch, the second electronic switch, and the third electronic switch is an n-channel metal-oxide semiconductor field-effect transistor (NMOSFET), and the first terminal, the second terminal, and the third terminal of each of the first electronic switch, the second electronic switch, and the third electronic switch are respectively corresponding to a gate, a drain, and a source of the NMOSFET.

10. The power supply system of claim 8, wherein a resistance of the first resistor is equal to a resistance of the fifth resistor, and a resistance of the second resistor is equal to a resistance of the sixth resistor.

11. The power supply system of claim 8, wherein the third voltage is a 5 volt (V) standby voltage.

12. The power supply system of claim 7, wherein the first voltage is a 5V voltage and the second voltage is a 5V auxiliary voltage.
